(19) United States
(12) Patent Application Publication
(10) Pub. No.: US 2019/0341789 A1
(43) Pub. Date: Nov. 7, 2019

(54) Power Sharing System

(71) Applicants: David R. Hall, Provo, UT (US); Christopher Jones, Spanish Fork, UT (US); Casey Webb, Spanish Fork, UT (US); Jerome Miles, Spanish Fork, UT (US)

(72) Inventors: David R. Hall, Provo, UT (US); Christopher Jones, Spanish Fork, UT (US); Casey Webb, Spanish Fork, UT (US); Jerome Miles, Spanish Fork, UT (US)

(21) Appl. No.: 15/972,361

(22) Filed: May 7, 2018

(51) Int. Cl. H02J 7/00

(52) U.S. Cl. CPC H02J 7/0027; H02J 7/0047; H02J 7/007

(57) ABSTRACT

There is disclosed a system for sharing power among interconnected tools which is made up of multiple battery-powered tools, each with a battery. Each tool and its battery are electrically connected to a hub, and the hub is adapted to provide charging current to each battery, to monitor the charge level of each battery and to direct current from one battery with a higher charge level to a battery with a lower charge level. The system is also adapted to enable the hub to direct power to corded electric tools.

### TECHNICAL FIELD

This invention relates generally to systems for sharing power among interconnected tools.

### BACKGROUND

Modern devices are designed to make life easier, they fulfill tasks that would take a person working without the device much longer. For example, before power drills people had to use their arms or hands to make the drill spin, while aided by gears this was still a time intensive process. Today electric and battery powered drill decrease the time necessary to accomplish a task. However, power drills whether corded or battery operated become worthless when there is no power to run them. Lack of power can result from power outages or depleted batteries. Currently if someone wants to use a power drill and the battery is depleted, they must either replace the battery or wait for it to recharge. Likewise, if the drill is corded and there is no source of electric power the drill becomes useless.

### SUMMARY

In a first aspect, the invention is a system for sharing power among interconnected tools and is made up of multiple battery-powered tools, each with a battery. Each tool and its battery are electrically connected to a hub, and the hub is adapted to provide charging current to each battery, to monitor the charge level of each battery and to direct current from one battery with a higher charge level to a battery with a lower charge level.

In a second aspect, the invention is, a system for sharing power among interconnected components. The system includes at least one corded electric tool, multiple battery-powered tools, each with a battery. The at least one corded electric tool is electrically connected to the hub, and each tool and its battery is electrically connected to the hub, forming an interconnected system. The hub is adapted to provide charging current to each battery, to monitor the charge level of each battery and to direct current from one battery with a higher charge level to a batter with a lower charge level. The hub is also adapted to direct power from any or all batteries to a corded electric tool.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a view of a system.

FIG. 2 is a view of the system attached to an overhead mounting system.

FIG. 3 is a system diagram.

FIG. 4 is a second system diagram.

FIG. 5 is a third system diagram.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

This application incorporates by reference all the subject matter disclosed in the following references: US Patent Application No. 20150284221A1 by David R. Hall et al., filed Apr. 3, 2014 and entitled “Compact Motorized Lifting Device”; US Patent Application Serial No. 20160236916A1 by David R. Hall et al., filed Apr. 27, 2016 and entitled “Multiple Motorized Lifting Devices Mounted to a Structure”; U.S. Pat. No. 9,860,361 by David R. Hall et al., filed Jan. 24, 2017 and entitled “Wirelessly Controlled Inflator”; U.S. patent application Ser. No. 15/426,556 by David R. Hall et al., filed Feb. 7, 2017 and entitled “Compact Inflator”; U.S. patent application Ser. No. 15/441,928 by David R. Hall et al., filed Feb. 24, 2017 and entitled “Intelligent Current Limiting to Enable Chaining of AC Appliances”; U.S. patent application Ser. No. 15/443,312 by David R. Hall et al., filed Feb. 27, 2017 and entitled “Intelligent Current Limiting to Enable Chaining of DC Appliances”; U.S. patent application Ser. No. 15/443,434 by David R. Hall et al., filed Feb. 27, 2017 and entitled “Intelligent Current Limiting to Enable Chaining of AC and DC Appliances”; U.S. patent application Ser. No. 15/487,999 by David R. Hall et al., filed Apr. 14, 2017 and entitled “Overhead Mounting System”; U.S. patent application Ser. No. 15/488,860 by David R. Hall et al., filed Apr. 17, 2017 and entitled “Overhead Mounting System for Daisy-Chained Devices.”

Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary. As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to produce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “tool” is meant to refer to all AC electrical instruments, devices and appliances, DC electrical instruments, devices and appliances, corded electric tools, battery-powered tools, accessories and other objects that connect to the system.

As used herein, “personal control device” is meant to refer to devices such as smart phones; tablet computing devices, such as iPad or Galaxy Tab; laptop computers; or other computing devices.

As used herein, “digital assistant” is meant to refer to computing devices including but not limited to: Amazon Echo, Amazon Echo Dot, Google Home, Google Home Mini, Nest, and HomePod.

As used herein, “hub” is meant to refer to a computing device that contains: a processor; non-transitory memory; a user interface; a microphone and is adapted to connect to a network and other devices, the connections can be wired or wireless.

Power tools and other electrical devices generally receive power in one of two ways; they plug into a source of power, such as a standard electrical outlet or they have a battery that supplies the power and works till it is depleted. There are various methods for charging batteries and for maintaining the charge. Power tools often have times of high load, that is times when they draw high amounts of power; this can lead to tripping a circuit or to failure of the tool.

To deal with these challenges, the inventors have developed a system that can share power between components connected to the system. In one aspect the power is shared to recharge a depleted battery quickly. In another aspect the power is shared to deal with a high draw by one component of the system.

The system is designed, in certain embodiments, to allow battery-powered tools to share power with each other and in certain embodiments, to provide power to corded electric tools in the event that there is no other source of power. In one embodiment, to enable connected batteries or multiple power sources to load share, or to share power, the batteries and power sources are connected together using a low forward voltage drop diode. For example, two power tools each equipped with batteries are connected, to each other, the tools and their batteries are also connected to a power source. When one of those battery-powered tools performs a function, that tool's battery will see a drop in potential, in other words the battery will be at least partially depleted. That drop in potential will forward bias the diode to start conducting. Once the diode starts conducting the power, in the higher potential battery, or the more charged battery, will drop until the batteries are at equal potentials, or equal power levels, with one another. When the power levels are equal, the current from the power source will be shared equally between the two battery-powered tools and their batteries as the batteries are recharged.

In another embodiment the load sharing is accomplished by configuring a metal-oxide-semiconductor field effect transistor (MOSFET) as an “ideal diode.” When one of the connected tools draws current it will trigger the MOSFET configured as an ideal diode. In one embodiment the MOSFET is connected to a processor, such as an MCU and the processor is configured to specifically control how much current each device and it's connected battery shares with the system.

In another embodiment, multiple batteries are connected to a hub that functions as the processor for the MOSFET and is programmed to monitor the potential of the batteries. The hub is programmed to use the gate of the MOSFET and control how much current is shared with the system through the ideal diode.

In one embodiment, several battery-powered tools are connected together and to a hub, which is designed to control the tools. The hub also monitors the tools, for example to determine how often they are used, the length of their use, what the charge on the battery of each tool is and other details of their operation and charge. In one embodiment, the battery-powered tools are selected from a winch, a laser (such as for assisting in parking a car), a camera and a light. In an example of operation, if the winch is used several times its battery could become depleted. The hub, which is monitoring the tools, senses the drop in potential for the battery of the winch and the hub instructs the MOSFET to share current to the winch's battery from the batteries of the other tools.

In another embodiment, several battery-powered tools and several corded electric tools are connected together and to the hub. One of the electric power tools, such as a table saw, requires higher levels of power than the system provides. When the table saw is turned on, the hub directs power from the battery of the winch, the battery of the park assist laser, the battery of the camera, and the battery of the light, in this way the system enables the table saw to get sufficient power to work.

In another embodiment, the hub is configured to redirect power from battery-powered tools to corded electric tools when the normal source of power for the corded electric tools is interrupted. For example, if the normal power to a house goes out, such as by a tree being knocked down in a storm that pulls down a power line; the power to the corded electrical tools in the system would be interrupted. A corded electric tool, for example an electric chain saw, is plugged into an attached power cord, that is connected to the system. Even though normal power to the house is cut off, if the electric chain saw is connected to the preferred system of the invention, it could be used to clear the area of debris left by the storm, as the hub directs power from the attached batteries through the attached power cord to the electric chain saw.

The hub continuously monitors the charge level in the battery of each of the battery-powered tools. In some embodiments, the hub will only direct power from a battery that has a charge level above twenty-percent charged. In some embodiments the hub will only direct power from a battery having a charge level above ten percent. In other embodiments the user determines the charge level at which a battery will no longer be permitted to contribute power into the system. In some embodiments this charge level will be different for different components. For example, in certain embodiments, the battery connected to a light will only distribute power until the charge level reaches seventy percent, in this way the user will be assured that the light will continue to function for a long period of time should the power remain out. In another embodiment the battery connected to the light will only distribute power until the charge level reaches eighty-five percent. In another embodiment the battery connected to a speaker will distribute power until the charge level reaches ten percent. The speaker is considered a less essential tool so the ability of the speaker to function is less important than the ability of the light to function. In some embodiments there are preset values for the level at which a tool will cease to distribute power from its battery. In other embodiments the user sets the level at which the tools cease to distribute power from their batteries.

The system requires communication between the various tools and the hub. This communication occurs either through the wired connections between all the tools and the hub. Alternatively, the communication occurs thought wireless means such as Bluetooth or Wi-Fi. In one embodiment communication occurs via is a wired communication. In some embodiments the communication occurs via a network, in certain embodiments the network is a Bluetooth mesh network, such as in embodiment wherein the devices utilize Bluetooth transceivers. In another embodiment the network is a Wi-Fi network. Various components integrated into the system are interconnected in a power supply scheme. Additionally, in one embodiment various components integrated into the system are integrated by an overhead mounting system.

In certain embodiments, the system is operated through an application, with a user interface, on a personal control device, such as a smart phone, a tablet, or any of a variety of personal computers or other computing devices. The personal control device allows the user to manually control any of the components. The user controls the components by manually inputting commands, such as commands provided through the user interface of an application associated with the entire system of connected components. By connecting all components together through the hub all products are able to communicate with each other through the hub. For example, a user could create settings that will turn on the connected fan every time the lights are turned on when the heat sensor on the fan identifies the temperature is above a predetermined threshold. Alternatively, a setting could be created that when the lights are turned on the fan is turned on as long as the motion sensor determines that there is movement. Connecting all components to the hub allows a user to determine which products are connected to the system. The user can see power consumption on the entire system and for each component individually since all products will report to the hub.

The system is configured so that power can be shared among the power tools. To share power the system is configured such that the corded electric tools, or AC electric tools, and battery-powered tools, or DC tools are connected to each other and to the hub. The tools are connected together and share power between their connections. It is necessary that AC and DC power be able to be utilized among the connected power tools and the hub. The connections between the tools are configured so that they are able to route the power to the tools that need it. The connections are also adapted to accommodate the levels of power being run through them. In one embodiment an AC electrical tool comprising an AC/DC power adaptor is used to adapt the power for the tools utilizing each type of power. The electrical tool comprising an AC/DC power adaptor comprises an AC electrical input, an AC electrical output, an AC conductor comprising an AC current-limiting device with an AC current limit common to multiple AC electrical tools, a DC electrical outlet, and a DC current-limiting device, which has a DC current limit.

In one embodiment all the DC tools with batteries are 12 V tools. In another embodiment all the DC tools with batteries are 24 V tools. In another embodiment the DC tools with batteries are a combination of 12 V and 24 V tools, in this embodiment the 24 V tools and their batteries are configured to charge with 1 A, i.e. with one amp to one volt, and the 12 V are configured with a 2 A connection i.e. with 2 amps per volt. The power or watts are amps multiplied by voltage (W=A*V). This way the power will remain constant and the system will share power

In one embodiment, the power sharing is being sent through a power cord, the AC electrical input of the AC electrical tool comprising an AC/DC power adaptor is a power cord. If a local source of electrical power is a typical 110- to 120-volt wall outlet with 15 to 20 amps of current. In one embodiment, the power cord comprises a three-prong plug. In other embodiments, the AC electrical input is another of many types of electrical connectors commonly known in the art. In one embodiment, the AC electrical input of the AC electrical tool comprising an AC/DC power adaptor is connected to a local source of electrical power, a standard wall outlet. Standard wall outlets often supply 15-20 amps of alternating current (AC) at 110 or 120 volts. In another embodiment, the AC electrical input of the AC electrical tool comprising an AC/DC power adaptor is connected to another AC electrical tool in a chain configuration, where one AC electrical tool in the chain is connected to a local source of electrical power. In one embodiment, the AC electrical output of the AC electrical tool comprising an AC/DC power adaptor comprises a standard electrical outlet into which a power cord can be plugged. In one embodiment, the AC electrical output is a three-pronged electrical outlet. In other embodiments, the AC electrical output is another one of many types of electrical connectors commonly known in the art. In one embodiment, another AC electrical tool is connected into the AC electrical output of the AC electrical tool comprising an AC/DC power adaptor. In one embodiment, another AC electrical tool comprising an AC/DC power adaptor is connected into the AC electrical output of the first AC electrical tool comprising an AC/DC power adaptor. Because the AC electrical tool comprising an AC/DC power adaptor has an AC electrical output, as well as a DC electrical outlet, AC power can be passed through the AC electrical tool comprising an AC/DC power adaptor to subsequent AC electrical tools connected to it in a chain configuration, and DC power can also be passed out the AC electrical tool comprising an AC/DC power adaptor along a separate line connected through the DC electrical outlet to subsequent DC electrical tools in a chain configuration. The DC power can be passed back through the AC/DC power adaptor to the AC electrical tools, or to other DC tools.

The AC conductor of the AC electrical tool comprising an AC/DC power adaptor comprises an AC current-limiting device. The AC current-limiting device has an AC current limit common to the plurality of AC electrical tools. The AC current-limiting device limits a flow of current in the AC conductor when the flow of current within the conductor approaches the AC current limit. The AC current-limiting device in each AC electrical tool in the chain configuration, including the AC current-limiting device in the AC electrical tool comprising an AC/DC power adaptor, designates the AC current limit. In one embodiment, the AC current limit is 10 amps. In one embodiment, the AC current limit is 15-20 amps, the limit of a standard wall outlet. In another embodiment, the AC current-limiting device is a digital current limiter, which comprises a transistor, a microcontroller, and one or more sensors that monitor voltage and current. These sensors help ensure that the power is routed to the correct device when power is being shared, which is particularly necessary when the power being shared is augmenting the standard power available. In one embodiment, the AC current-limiting device is located on a printed circuit board. In one embodiment, the AC current-limiting device is located along the main circuit—the live wire—that connects the AC electrical tool comprising an AC/DC power adaptor to each AC electrical tool in the chain configuration. In another embodiment, the AC current-limiting device comprises a current monitor, and the monitor is connected to a breaker located on a circuit that powers components of the AC electrical tool comprising an AC/DC power adaptor. In one embodiment, the AC conductor is integrated into a printed circuit board (PCB).

In one embodiment, the AC electrical tool comprising an AC/DC power adaptor passes AC power on to subsequent AC electrical tools in a chain configuration along one circuit, but on another circuit, the AC electrical tool comprising an AC/DC power adaptor converts AC power supplied by the local source of electrical power or previous AC electrical tools in the chain to DC power, passing DC power along to subsequent DC electrical tools. Therefore, the AC electrical tool comprising an AC/DC power adaptor has an AC electrical output and a DC electrical outlet. Because the AC electrical tool comprising an AC/DC power adaptor has an AC electrical output, as well as a DC electrical outlet, AC power can be passed through the AC electrical tool comprising an AC/DC power adaptor to subsequent AC electrical tools connected in a chain configuration to the AC electrical output 1, and DC power can also be passed out the AC electrical tool comprising an AC/DC power adaptor along a separate line connected through the DC electrical outlet at the same time. The DC power is stored by batteries attached to the DC tools. The DC power can be shared back to the AC/DC power adaptor and redistributed to AC tools.

In one embodiment multiple AC electrical tools and DC tools with batteries are connected in a chain configuration to each other and to a local source of electrical power, wherein the plurality of AC electrical tools comprises one or more AC/DC power adaptors, and one or more DC electrical tools connected to the one or more AC electrical tools that comprise AC/DC power adaptors and to each other in one or more chain configurations. The local source of electrical power is generally a standard wall outlet. Each AC electrical tool comprises an AC electrical input, an AC electrical output, and an AC conductor comprising an AC current-limiting device with an AC current limit common to the plurality of AC electrical tools. Each AC conductor connects the AC electrical input and the AC electrical output. Each AC conductor has a current-carrying capacity greater than the AC current limit. One or more of the plurality of AC electrical tools comprise AC/DC power adaptors. The AC/DC power adaptors comprise an AC electrical input, an AC electrical output, and an AC conductor comprising an AC current-limiting device with a current limit common to the plurality of AC electrical tools, a DC electrical outlet, and a DC current-limiting device, which has a DC current limit. Each DC electrical tool comprises a DC electrical input, a DC electrical output, and a DC conductor. Each DC conductor connects the DC electrical input and the DC electrical output. Each DC conductor has a current-carrying capacity greater than the DC current limit of the DC current-limiting device. The one or more DC electrical tools are connected to the one or more AC electrical tools comprising AC/DC power adaptors and to each other in one or more chain configurations. In one embodiment, the plurality of AC electrical tools, including the AC/DC power adaptors, and the one or more DC electrical tools are connected to each other and to the local source of electrical power in a parallel circuit.

In one embodiment, one or more of the plurality of AC electrical tools comprise AC/DC power adaptors. One or more DC electrical tools are connected to the one or more AC/DC power adaptors and to each other in one or more chain configurations. In one embodiment, one chain of DC electrical tools extends from each AC/DC power adaptor. Each AC/DC power adaptor converts AC power from the local source of electrical power and the AC electrical tool chain to DC power. In one embodiment, each AC/DC power adaptor supplies direct current (DC) power at 14 volts.

In one embodiment, the one or more DC electrical tools are connected in a chain configuration to each AC/DC power adaptor and to each other by means of the DC electrical input and the DC electrical output of each DC electrical tool. In this embodiment, the AC electrical input of each AC/DC power adaptor is connected to the chain of AC electrical tools, which is connected to the local source of electrical power. The DC electrical input of one DC electrical tool is connected to the DC electrical outlet of one AC/DC power adaptor. The DC electrical input of a second DC electrical tool is connected to the DC electrical output of the first DC electrical tool. The DC electrical input of a third DC electrical tool is connected to the DC electrical output of the second DC electrical tool, and so on, until a chain configuration of the DC electrical tools is formed. This can be repeated with another one or more AC/DC power adaptors in the AC chain, creating one or more additional DC chain configurations.

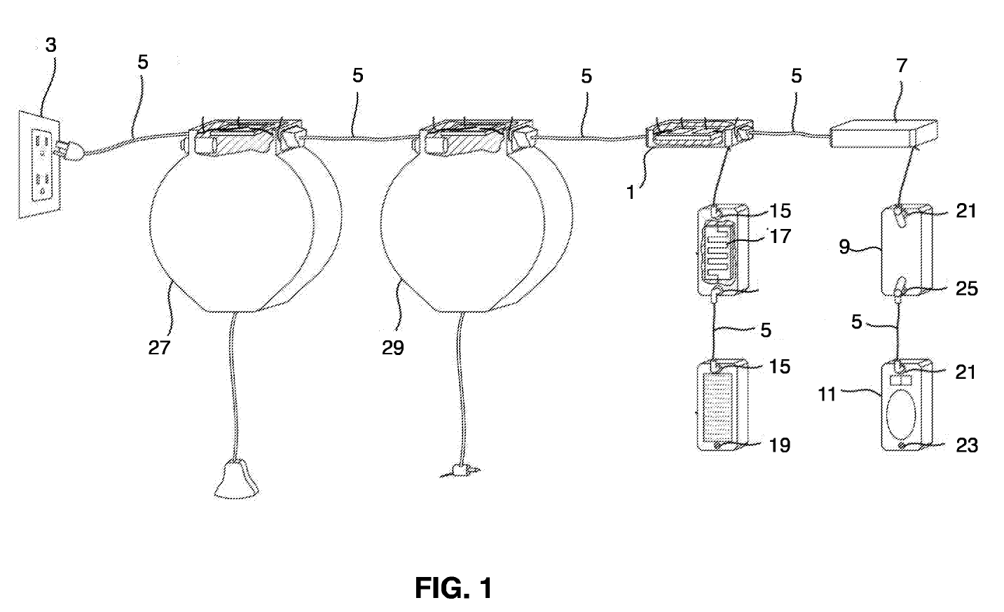

Turning to FIG. 1, the hub 1, and power tools are electrically connected to a standard power outlet 3 providing 110 volts. The power cord 27 and inflator 29 run on corded power, i.e. without batteries. Battery-powered tools; light 17, park assist laser 9, camera 19, and speaker 11, are also attached to the system. In one embodiment, the light 17 is left on and the battery depleted, the system automatically begins recharging the battery when it reaches a low threshold, preferably at ten percent capacity. Before the battery of the light 17 is charged sufficiently to use again, the light is turned on, the hub sensing that the battery is insufficiently charged to use redirects power from the batteries of the park assist laser 9, the camera 19 and the speaker 11. This redirection of power allows the battery in the light 17 to be recharged very quickly, because the redirected power came from several sources none of the batteries providing the power are completely drained. It is beneficial to not drain the batteries providing power completely so that will have power should they be used.

As an example of the usefulness of the preferred embodiment, if the power goes out and the light 17 is left on, the battery of the light 17 is depleted, Then, when the light is turned on, the hub senses that the battery is depleted and redirects power from the batteries of the park assist laser 9, the camera 19 and the speaker 11. The redirection of power from the batteries of the park assist laser 9, the camera 19, and the speaker 11 charge the battery of the light and allows the light to turn on.

As another example of usefulness, if there was a powerful ice storm and the ice collecting on the power transmission cables snapped a cable, the house would be left without power. The family decides to go to a relative's house to be warm while the power company fixes the power lines. As they go to their car they discover that the car has a flat tire. The family fortunately has the smart power distribution system installed, which allows them to use inflator 29. Inflator 29 is attached to the tire and turned on; the hub redirects power from the battery of the light 17, the battery of the speaker 11, the battery of the park assist laser 9, and the battery of the camera 19. The inflator inflates the tire, and the family leaves to get warm. In some embodiments, the hub is programmed to divert power from some battery-powered tools and not others. For example, the hub 1 is programmed to not divert power from the battery in the light 17, so that the light 17 will have sufficient power to function and provide illumination allowing the users to see. In other embodiments the hub is programmed not to redirect power to certain electrical tools when the standard electrical power is not functioning. This allows the users to program non-essential tools to not utilize the limited power stored in the batteries.

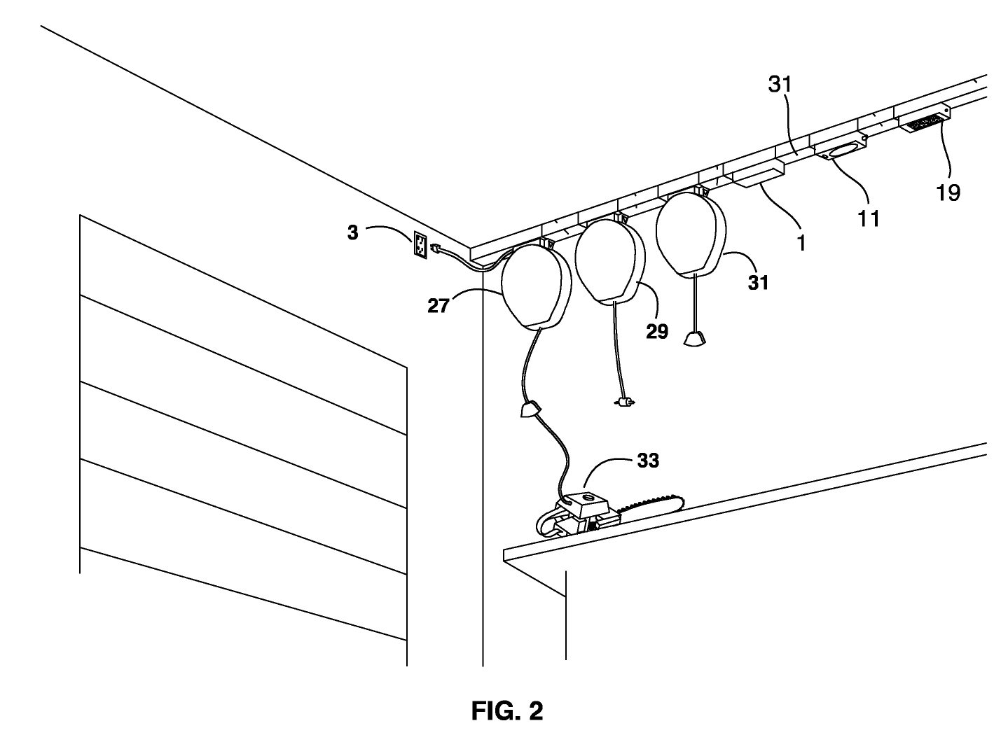

In FIG. 2, the system is connected to an overhead mounting system 33. The overhead mounting system has several advantages for the system; the tools and components are mounted overhead where they are out of the way, the overhead mounting system 33 has a channel for keeping the electric connection cords out of sight. The system is able to connect and better utilize space. The system connects to its normal power source, i.e. the power supply of the residence or workspace, through outlet 3, the tools connect to each other and cords are hidden in overhead mounting system 31. Corded electric tools; power cord 27, inflator 29, and power cord 31 run on electric power from outlet 3. Power cord 29 is connected to chain saw 33. Battery-powered tools hub 1, speaker 11, and light 19 are also connected to power outlet 3 and are connected to the overhead mounting system and to each other. When the normal power is interrupted the battery-powered tools share power to power connected corded electric tools. For example, if the normal power to a house goes out, such as by a tree being knocked down in a storm that pulls down a power line; the power to the corded electrical tools in the system would be interrupted. A corded electric tool, for example electric chain saw 33, is plugged into power cord 29. Even though normal power to the house is cut off, if the electric chain saw 33 is connected to the preferred system of the invention, it could be used to clear the area of debris left by the storm, as the hub directs power from the attached batteries of the light 19 and speaker 11 through the attached power cord to the electric chain saw 33.

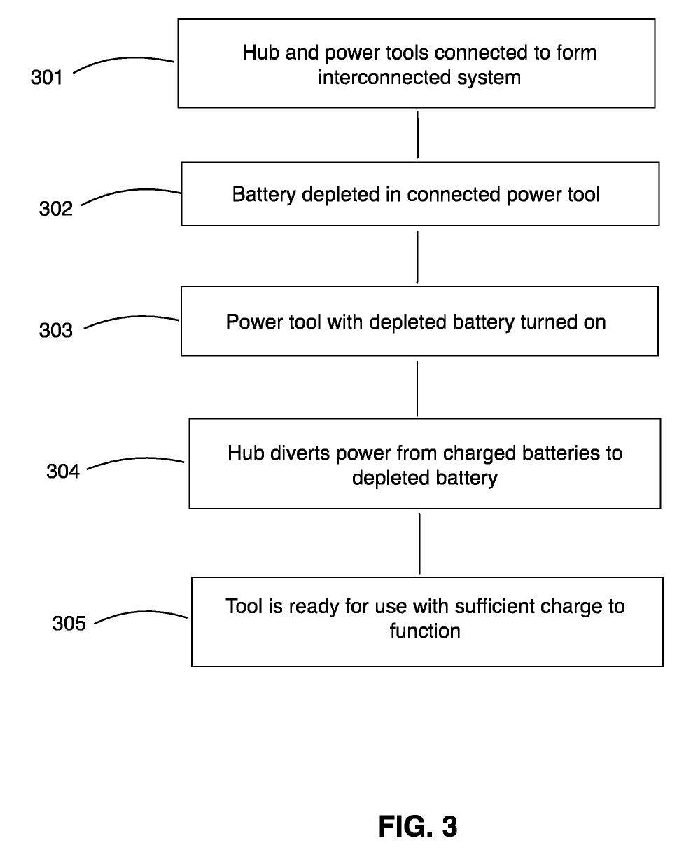

Turning now to FIG. 3, the hub and power tools are connected electrically and communicatively to form an integrated system 301. When a battery is depleted in a connected power tool 302 and the power tool with the depleted battery is turned on 303, the hub detects that the battery is depleted and shares power from charged batteries to the depleted battery 304. The tool is ready for use with sufficient charge to function. In some embodiments the charge sufficient to function will mean that the battery has reached a charged capacity above a certain threshold. In other embodiments the charge sufficient to function will be that the battery has been fully charged.

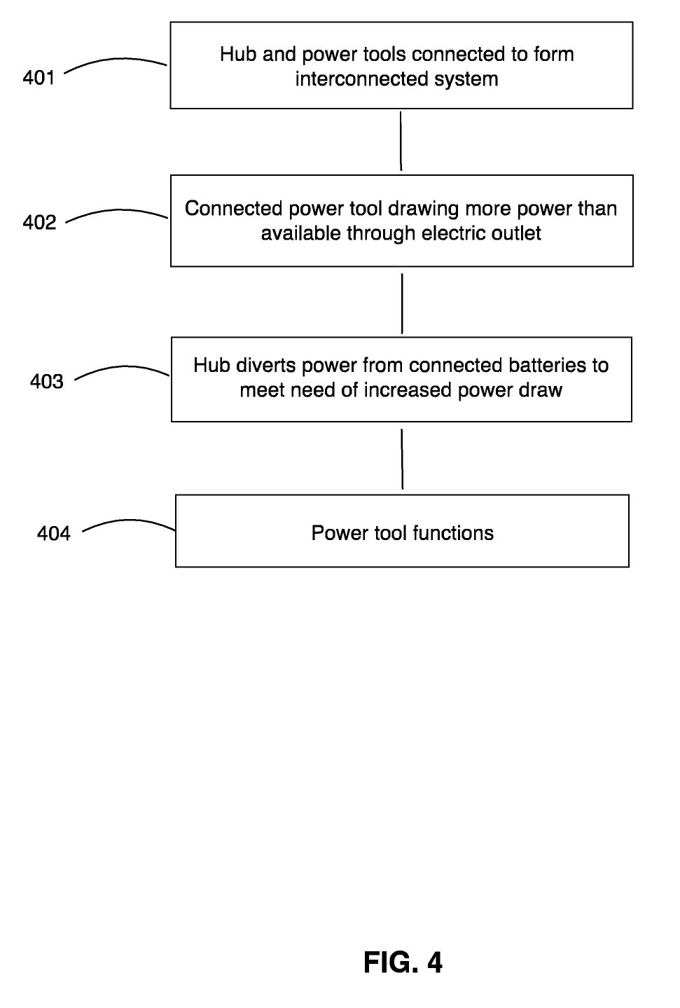

Referring to FIG. 4, the hub and power tools are connected electrically and communicatively to form an integrated system 401. A connected power tool draws more power than is available through the standard electric outlet 402. The hub detects the increased power draw and shares power from connected batteries to meet the need of the increased power draw 403. The power tool functions 404.

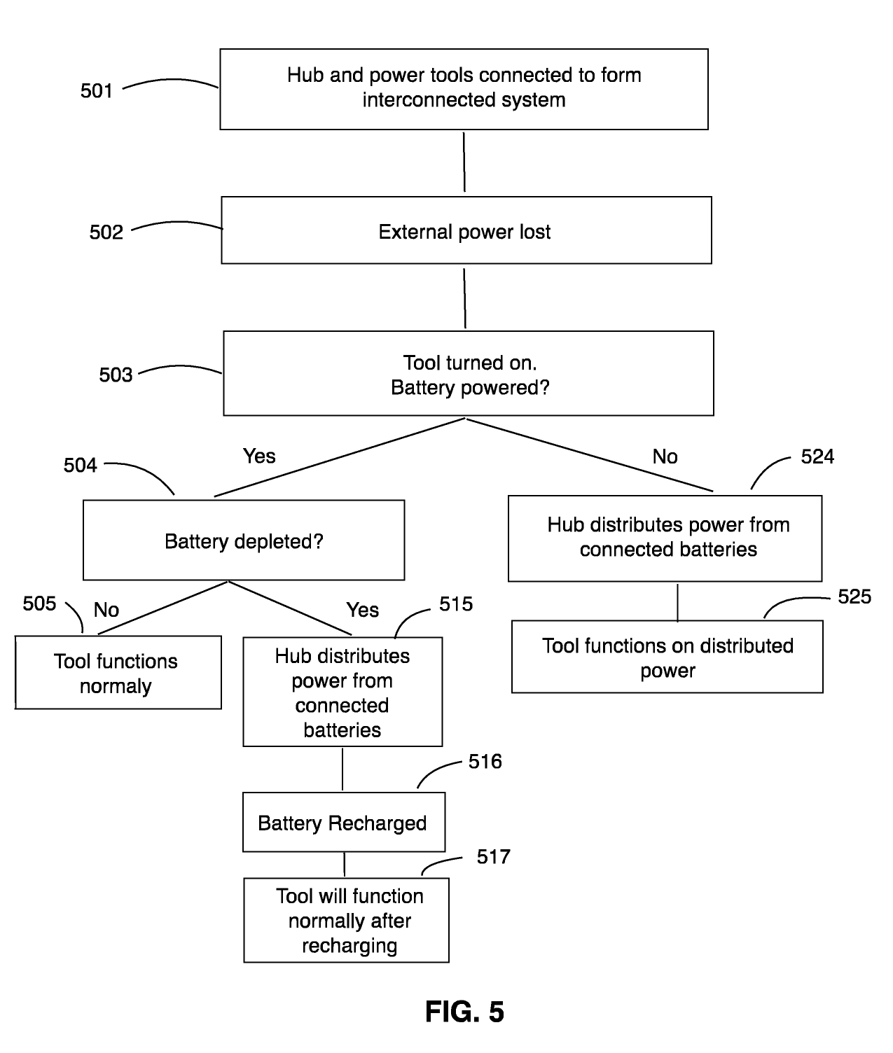

Referring to FIG. 5, the hub and power tools are connected electrically and communicatively to form an integrated system 501. External power is lost 502. A power tool is turned on. Is it battery-powered 503? When the response is yes, the power tool is battery-powered, the next step is determined by a second query, is the battery depleted 504. When the response is no, the tool functions normally 505. When the response is yes, the battery is depleted, the hub shares power from other connected batteries 515. The battery is recharged 516. The tool will function normally after recharging. Returning to the query of if the tool is battery-powered 503. When the response is no, the tool is not battery-powered the hub shares power from connected batteries 524. The tool functions on the shared power 525.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A system for sharing power among interconnected tools comprising:
multiple battery-powered tools, each with a battery; and
a hub;
wherein each tool and its battery are electrically connected to the hub; and
wherein the hub is adapted to provide charging current to each battery, to monitor the charge level of each battery and to direct current from one battery with a higher charge level to another battery with a lower charge level.

2. The system of claim 1 further comprising a user interface adapted to provide charge level information about each tool to a user.

3. The system of claim 2 wherein the user interface and hub are adapted so as to receive instructions from the user.

4. The system of claim 3 wherein the user interface is adapted to connect with a personal control device.

5. The system of claim 1, wherein the hub and each tool are connected to a data network, and wherein the hub monitors the charge level of each tool over the data network.

6. The system of claim 5, further comprising a user interface, which is also connected to the data network.

7. The system of claim 1, wherein the hub directs current from a single battery with a higher charge level to a battery with lower charge level.

8. The system of claim 1, wherein the hub directs current from multiple batteries with a higher charge level to a battery with lower charge level.

9. The system of claim 1, wherein the hub directs current from batteries with a higher charge level to a battery with lower charge level, till a minimum threshold charge is reached by the receiving battery.

10. A system for sharing power among interconnected tools comprising:
at least one corded electric tool;
multiple battery-powered tools, each with a battery; and
a hub;
wherein the at least one corded tool is electrically connected to the hub;
wherein each battery-powered tool and its battery is electrically connected to the hub;
wherein the hub is adapted to provide charging current to each battery, to monitor the charge level of each battery and to direct current from one battery with a higher charge level to a batter with a lower charge level; and
wherein the hub is adapted to direct power from any or all batteries to the corded electric tool.

11. The system of claim 10, wherein the hub directs power from the batteries to the corded electric tool when it is drawing more power.

12. The system of claim 10, wherein power is directed to the corded electric tool when there is no external source of power.

13. The system of claim 10, wherein the hub and each tool are connected to a data network, and wherein the hub monitors the power being drawn by each tool over the data network.

14. The system of claim 1 further comprising a user interface adapted to provide power draw level information about each tool to a user.

15. The system of claim 14, wherein the user interface and hub are adapted so as to receive instructions from the user.

16. A method for sharing power among interconnected components comprising:
electrically connecting multiple battery-powered tools, each with a battery, to a hub;
monitoring, through hub, the charge level of each battery;
providing, from the hub, charging current to each battery as needed and directing current from one battery with a higher charge level to another battery with a lower charge level as needed.

17. The method of claim 16, wherein a single battery provides the charging current.

18. The method of claim 16, wherein multiple batteries provide the charging current.

19. The method of claim 16, further comprising connecting at least one power tool.

20. The method of claim 19, wherein the hub directs power from the multiple batteries to the at least one power tool.
